(19) United States
(12) Patent Application Publication
(10) Pub. No.: US 2015/0356208 A1
(43) Pub. Date: Dec. 10, 2015

(54) METHOD FOR GENERATING AN ENHANCED DIGITAL MOCKUP

(71) Applicant: AIRBUS GROUP SAS, PARIS (FR)

(72) Inventors: NICOLAS CHEVASSUS, CHAVILLE (FR); DENIS MARRAUD, ISSY LES MOULINEAUX (FR); ANTOINE TARAULT, PARIS (FR); XAVIER PERROTTON, CHATILLON (FR)

(21) Appl. No.: 14/720,772

(22) Filed: May 23, 2015

(30) Foreign Application Priority Data
Jun. 4, 2014 (FR) 14 55054

(51) Int. Cl. G06F 17/50

(52) U.S. Cl. CPC G06F 17/50

(57) ABSTRACT

A method for generating a digital mockup in three dimensions using computer-aided design (CAD) software. The digital mockup is integrated into a spatialization environment for the digital mockup allowing visualization of the digital mockup from various angles of view. The digital mockup is produced to obtain a semi-finished product. A plurality of pieces of production information is acquired. For each piece of production information, a spatial position linked to the production information is measured, and the production information is integrated into the spatialization environment on the digital mockup at a position in the digital mockup corresponding to the measured spatial position.

### FIELD OF THE INVENTION

The present invention relates to a method for generating an enhanced digital mockup, that is to say having information from a design office and information from a production phase.

The invention can be used in a large number of fields such as aeronautics, building, marine construction or else space construction.

The present invention can be applied more particularly to large-sized objects such as aircraft, helicopters or else satellites.

### PRIOR ART

Knowledge of the condition of a real object in the course of manufacture or during service is often partial. An industrialist generally has a collection of measurements in folders (for example spreadsheets, photographs or measurement files) or in databases. It is then difficult, particularly for large-sized objects, not only to find the measurements from reality that are associated with a particular area and to understand where the measurements were taken but especially also to connect them and to match them to one another or with regard to a digital mockup of three-dimensional design. As a result, it is not easy to understand the condition in the course of manufacture or during service.

The design of a large-sized object often requires production of a construction mockup. In order to improve the precision of this mockup, it can be produced in three dimensions using computer-aided design (CAD) software. Some software, for example CATIA (registered trade mark from the company Dassault Systeme) software, allows integration of the digital mockup into a spatialization environment allowing visualization of the digital mockup from various angles of view. This digital mockup thus allows project managers to be afforded guidance for construction of the finished product.

Before obtaining a finished product, operators make regular checks on the production steps for the product in the course of production or the “semifinished” product. These checking steps allow a plurality of pieces of production information to be acquired that can differ from the definition expected on the digital mockup. For example, in the field of aeronautics, the construction of an aircraft is checked in each step for quality control operators, whose role is to detect and declare “nonconformity” between the digital mockup and the product that has been produced or is being produced, called a semi-finished product.

The decision-taking in the event of a discrepancy from the expected definition requires visits to the site in order to see the condition of the semifinished product for oneself. Visits to site allow a definition of the real object to be attained in the course of production or during service by means of spatial cross-requests, allow site statements, measurements or annotations to be synthesized and allow discrepancies between the real product and its digital design mockup to be analyzed.

At present, all heterogeneous references are generally grouped into one or more databases (sometimes simply by means of files). These data can be managed in terms of configuration in configuration management systems and are accessible following requests in the form of lists. The simulation or test results can be returned to the networks that have been used to obtain them or to predict them, but firstly the networks are already idealized representations of the product that come from the design CAD and secondly the environments allowing this visualization are dedicated to the calculation and analysis of specific physical components. In this regard, they do not allow synthesis of the capture of the real product with regard to its reference definition shaped by a digital mockup.

### SUMMARY OF THE INVENTION

The aim of the present invention is to overcome the disadvantages of the prior art by proposing a three-dimensional spatialization environment for the digital mockup enhanced by production information for the finished product or for the semifinished product.

To this end, the present invention concerns a method for generating a digital mockup comprising the following steps: design of a digital mockup in three dimensions using computer-aided design (CAD) software, integration of the digital mockup into a spatialization environment for said digital mockup allowing visualization of said digital mockup from various angles of view, production of said digital mockup in order to obtain a semifinished product, acquisition of a plurality of pieces of production information, and, for each piece of production information: measurement of a spatial position linked to said production information, and integration of said production information into the spatialization environment on said digital mockup at a position in said digital mockup corresponding to the measured spatial position.

The invention thus allows an enhanced digital mockup, that is to say one containing the design information and production information, to be obtained. This enhanced digital mockup allows quality controls to be performed between the semifinished product and the digital mockup. Furthermore, the invention allows declaration and documentation of nonconformities in augmented reality on a semifinished product and the use of said nonconformities in said industrial design software.

For example, in the field of aeronautics, a nonconformity can be detected by a control operator who is different from the person qualified to put right this problem. This nonconformity detection leads to a process of study of the nonconformity and, if need be, of correction of said nonconformity. The geolocation of nonconformities in the spatialization environment allows the steps of study and correction to be facilitated besides limitation of multiple detection of the nonconformities. Furthermore, the geolocation of nonconformities in the spatialization environment allows, if need be, design errors in the digital mockup to be resolved.

According to an embodiment, the production information corresponds to a measurement for a piece of said semifinished product. This embodiment allows integration of the quality controls that are performed on said semifinished product and deduction of a measure of tolerance for the production therefrom.

According to one embodiment, the production information corresponding to a shot of a portion of said semifinished product, the method has a step of adaptation of said shot to said digital mockup. This embodiment allows integration of the shots of two or three dimensions into the spatialization environment. In particular, this embodiment is particularly effective for performing a check on the positioning of a plurality of elements of a semi-finished product.

According to an embodiment, the production information corresponding to a measurement in three dimensions for a surface of said semifinished product, the method has a step of matching and integration of said surface geared to said digital mockup. This embodiment allows integration of the surface measurements into the spatialization environment. In particular, this embodiment allows detection of the impacts on a structure of a semifinished product. In the case of a composite structure, each undetected impact can cause weakening of the structure.

According to an embodiment, the production information corresponding to a plurality of annotations relating to one and the same spatial position, the method has a step of interleaving of the isolated annotations localized in one and the same area. This embodiment allows limitation of the necessary calculations for visualization of the digital mockup and/or of the semifinished product in the spatialization environment.

According to an embodiment, the spatialization environment having a plurality of levels of details associated with the plurality of masks, the method has a step involving masking some production information or some information from said digital mockup according to a selected level of detail. This embodiment likewise allows limitation of the necessary calculations for visualization of the digital mockup and/or said semifinished product in the spatialization environment.

According to an embodiment, the method comprises a step involving masking some production information or some information from said digital mockup according to the visualization position in said spatialization environment. This embodiment likewise allows limitation of the necessary calculations for visualization of the digital mockup and/or of said semifinished product in the spatialization environment, for example the elements that are present in a closed housing.

According to an embodiment, some production information being associated with a date, the method has a step involving masking some production information according to a selected date. This embodiment allows visualization of the change in a semifinished product in the course of its production.

According to an embodiment, the method comprises the following steps:

acquisition of a plurality of pieces of maintenance information, and, for each piece of maintenance information: measurement of a spatial position linked to said maintenance information, and integration of said maintenance information into the spatialization environment on said digital mockup at a position in said digital mockup corresponding to the measured spatial position.

This embodiment allows maintenance of a finished product to be facilitated by integrating wear measurements. This enhanced digital mockup allows a change in the flaws in the finished product to be obtained. This enhanced digital mockup likewise constitutes documentation of the intervention operations relying on an enhanced content between a real content and a virtual content. This embodiment likewise allows an improvement in comprehension and the search for test instrumentation for the finished products.

### BRIEF DESCRIPTION OF THE DRAWINGS

The invention will be better understood with the aid of the description, which is provided below purely by way of explanation, of an embodiment of the invention, with reference to the figures, in which:

FIG. 1 is a flow chart representing the method according to an embodiment of the invention; and

FIG. 2 illustrates a spatialization environment according to an embodiment of the invention.

### DETAILED DESCRIPTION OF THE EMBODIMENTS OF THE INVENTION

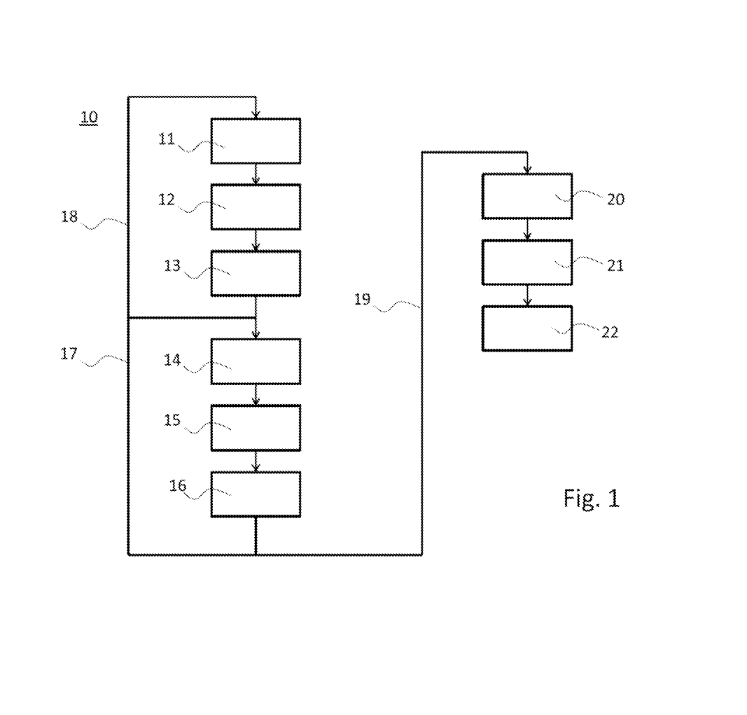

FIG. 1 is a flow chart representing the method according to an embodiment of the invention. In a first, design step 11, a product is imagined and designed in a design office. This design step 11 allows the obtainment of a digital mockup 30 in three dimensions X, Y and Z. In a second, integration step 12, the digital mockup 30 is implemented in a spatialization environment 31 allowing visualization of said digital mockup 30 from various angles of view. The spatialization environment 31 corresponds to a graphics engine, preferably in three dimensions. This spatialization environment 31 allows the digital mockup 30 to be observed with a high level of precision in order to facilitate the steps of production 13 of the digital mockup 30.

In the course of the steps of production 13 of the semifinished product, it is necessary to carry out quality controls on the semifinished product. To do this, operators perform a step of acquisition 14 of production information 35-39. For each piece of production information 35-39 that is collected, the operator measures 15 a spatial position linked to the production information 35-39 that is collected using a geolocation device for example. The collected production information 35-39 is then integrated 16 into the spatialization environment 31 on the digital mockup 30 at a position in said digital mockup 30 corresponding to the measured spatial position.

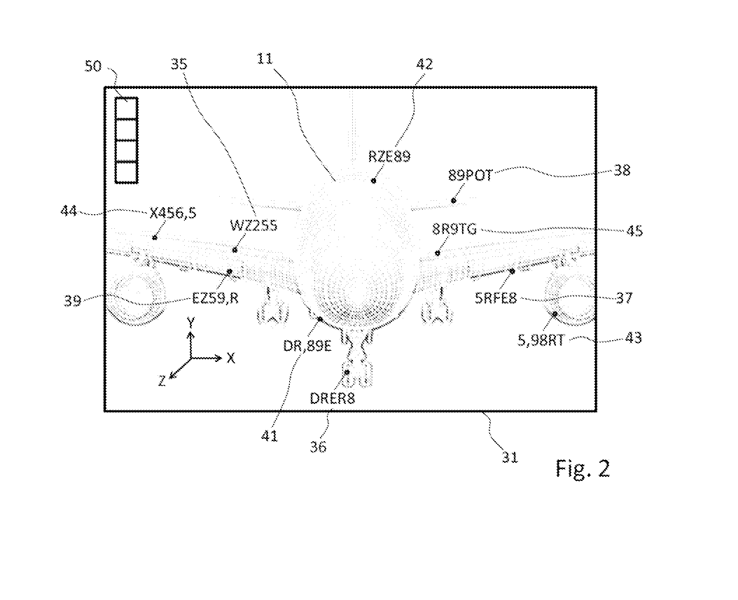

The spatialization environment 31 obtained in this manner is shown in FIG. 2. The digital mockup 30, representing an aircraft, is integrated in three dimensions X, Y and Z at the centre of the spatialization environment 31. The production information 35-39 is geolocated on the structure of the aircraft at the measured spatial position. The production information 35-39 may be of different type. The production information 35-39 may be annotations or measurements performed on the aircraft, for example the length of a part. When a plurality of measurements and/or a plurality of annotations are performed at one and the same point or at nearby points, this production information 35-39 can be interlinked in order to limit display of the last relevant piece of information. The production information 35-39 can likewise correspond to shots in two or three dimensions. These shots are then geared to the digital mockup 30 and integrated on the latter. Using all these functionalities, the control operators who detect a nonconformity between the semifinished product and the digital mockup 30 can clearly reference the information.

In order to facilitate the reading of all this production information 35-39, the spatialization environment 31 can have means for masking the information whose measured spatial position is not visible to the operator. The spatialization environment 31 can likewise have a plurality of levels of detail 50 associated with a plurality of masks. The operator can thus select the level of detail that he wishes to visualize.

Equally, the production information 35-39 can be associated with a date so that the operator is able to mask some production information 35-39 from the spatialization environment 31 according to a selected date.

When the product has been produced entirely, the digital mockup 30 enhanced with the production information 35-39 can then be used for maintenance operations. To do this, a maintenance operator acquires a plurality of pieces of maintenance information 41-45 that are geolocated and integrated on the digital mockup 30. For example, if a crack is detected on the tailplane of an aircraft, a three-dimensional scan of the crack is performed and then integrated in the digital mockup 30. A design office can then take the digital mockup 30 as a basis for calculating whether or not this crack needs to be repaired according to the structure of the aircraft at the crack. Moreover, the change in the crack can be checked over time in order to confirm that it does indeed follow the envisaged damage model.

The invention thus has many advantages for checking the production and use of a computer-aided product.

Firstly, the digital mockup 30, which is produced in the design phase, is enhanced with data from reality that are geolocated and then aligned with the design model. The operator thus has an enhanced representation of the product allowing these data to be situated and allowing comprehension of the condition and the configuration of the product in the course of manufacture or during service and allowing analysis of the discrepancies between an expected condition and a recorded condition.

Moreover, an operator can find, on the real object, all of the annotations already performed so as, for example, to avoid retaking a measurement or supplementing the set of existing measurements with a new measurement in an unexplored area or even declaring a nonconformity with the design model.

1-9. (canceled)

10. Method for generating a digital mockup, comprising the steps of:
designing a digital mockup in three dimensions (X, Y, Z) using a computer-aided design software;
integrating the digital mockup into a spatialization environment for the digital mockup allowing visualization of the digital mockup from various angles of view;
producing the digital mockup to obtain a semi-finished product, and
acquiring a plurality of pieces of production information;
for each piece of production information, measuring a spatial position linked to said each piece of the production information, and integrating said each piece of the production information into the spatialization environment on the digital mockup at a position in the digital mockup corresponding to the measured spatial position.

11. Method according to claim 10, wherein the production information corresponds to a measurement for a piece of the semi-finished product.

12. Method according to claim 10, wherein the production information corresponds to a shot of a portion of said semi-finished product; and further comprising the step of adapting the shot to the digital mockup.

13. Method according to claim 10, wherein the production information corresponds to a measurement in three dimensions (X, Y, Z) for a surface of the semi-finished product; and further comprising the step of matching and integrating the surface geared to the digital mockup.

14. Method according to claim 10, wherein the production information corresponds to a plurality of annotations relating to one spatial position; and further comprising the step of interleaving of the isolated annotations localized in one area.

15. Method according to claim 10, wherein the spatialization environment comprises a plurality of levels of details associated with a plurality of masks; and further comprising the step of masking some production information or some information from the digital mockup according to a selected level of detail.

16. Method according to claim 10, further comprising the step of masking some production information or some information from the digital mockup according to a visualization position in the spatialization environment.

17. Method according to claim 10, wherein some production information is associated with a date; and further comprising the step of masking some production information according to a selected date.

18. Method according to claim 10, further comprising the steps of:
acquiring a plurality of pieces of maintenance information; and
for each piece of maintenance information, measuring a spatial position linked to said each piece of the maintenance information, and integrating said each piece of the maintenance information into the spatialization environment on the digital mockup at a position in the digital mockup corresponding to the measured spatial position.
